(19) United States
(12) Patent Application Publication
(10) Pub. No.: US 2015/0180062 A1
(43) Pub. Date: Jun. 25, 2015

(54) FUEL CARTRIDGE

(71) Applicant: Coretronic Corporation, Hsin-Chu (TW)

(72) Inventors: JIE-REN KU, Hsinchu County (TW); CHUNG-PING WANG, Hsinchu County (TW); YU-HSIANG LIN, Hsinchu County (TW); YU-WEN LU, Hsinchu County (TW)

(21) Appl. No.: 14/328,991

(22) Filed: Jul. 11, 2014

(30) Foreign Application Priority Data
Dec. 19, 2013 (CN) 201310727367.9

(51) Int. Cl. H01M 8/04

(52) U.S. Cl. CPC H01M 8/04208; H01M 8/04216

(57) ABSTRACT

A fuel cartridge includes an outer housing including a top wall, a bottom wall and a plurality of side walls; a storage container stored with a liquid reactant; a solid reactant including a top surface; a transmission device connected between the storage container and the solid reactant and for transmitting the liquid reactant to the solid reactant; a flexible thin film having gas permeability and water impermeability and disposed between the top and bottom walls and located above the top surface of the solid reactant; and an elastic waterproof membrane connected to the plurality of side walls of the outer housing and disposed between the storage container and the flexible thin film.

### FIELD OF THE INVENTION

The present invention relates to a fuel cartridge, and more particularly to a fuel cartridge for supplying a gas to a fuel cell for electricity generation.

### BACKGROUND OF THE INVENTION

By having some advantages such as high efficiency, low noise, low pollution, fuel cells have become the main trend in energy technology. Therefore, up to now many patents related to fuel cells have been published or disclosed, for example, U.S. Pat. Nos. 7,323,148, 7,666,386 and 7,914,652, U.S. Patent Publication No. 20110076225, 20040120889, 20070020172, 20080116063, 20030165727 and 20120045388, Japan Patent Publication No. 2006-160545, Taiwan Patent Publication No. 200809125 (corresponding to U.S. Patent Publication No. 20080233462) and 200302596 (corresponding to U.S. Patent Publication No. 20030138679), and Taiwan Patent No. 1328620 (corresponding to U.S. Patent Publication No. 20030235724), I372485 and I369812.

In the prior art, a fuel cartridge is used to provide hydrogen gas to the fuel cell for electricity generation, and may include a storage container and a solid reactant; wherein the solid reactant may include sodium borohydride (NaBH₄) and catalyst. When a liquid reactant, such as water, stored in the storage container is supplied to the solid reactant to react with sodium borohydride and catalyst by contacting the three with one another, a hydrogen gas is generated.

However, bubbles may be generated with the hydrogen gas when water is pumped out from the storage container and then delivered to the solid reactant for the reaction. These formed bubbles may easily enter into the fuel cell through a vent of the fuel cartridge, which may lead to damage to the fuel cell. In addition, when the fuel cartridge is inverted, the liquid mixed with the dissolved solid reactant and the liquid reactant may flow into the fuel cell through the vent due to the effect of gravity, which may also lead to damage to the fuel cell. Thus, it is quite necessary to provide a fuel cartridge capable of solving the aforementioned issues.

### SUMMARY OF THE INVENTION

The present invention provides a fuel cartridge capable of preventing the formed bubbles from entering into a fuel cell through a vent and thereby preventing damage to the fuel cell from occurring.

To achieve the above-mentioned advantages, the present invention discloses a fuel cartridge, which includes an outer housing, a storage container, a solid reactant, a transmission device, a flexible thin film and an elastic waterproof membrane. The outer housing includes a top wall, a bottom wall and a plurality of side walls connected between the top and bottom walls; wherein a vent is disposed in the outer housing. The storage container is stored with a liquid reactant. The solid reactant is disposed in the outer housing and includes a top surface. The transmission device is connected between the storage container and the solid reactant and for transmitting the liquid reactant to the solid reactant. A gas is generated from a reaction of the solid reactant with the liquid reactant, and the generated gas is then discharged through the vent. The flexible thin film has gas permeability and water impermeability. The flexible thin film is disposed between the top and bottom walls and located above the top surface of the solid reactant. An orthographic projection of the flexible thin film on a plane where the top surface of the solid reactant is completely covers the top surface. The elastic waterproof membrane is connected to the plurality of side walls of the outer housing and disposed between the storage container and the flexible thin film.

In one embodiment, the flexible thin film is connected to the plurality of side walls and thereby an interior of the outer housing is divided into a first chamber and a second chamber, wherein the first chamber is defined between the top wall and the flexible thin film and the second chamber is defined between the bottom wall and the flexible thin film.

In one embodiment, the vent is disposed in one of the plurality of side walls and located between the elastic waterproof membrane and the flexible thin film.

In one embodiment, the storage container is disposed in the first chamber and the solid reactant is disposed in the second chamber.

In one embodiment, all surfaces of the solid reactant are wrapped by the flexible thin film.

In one embodiment, the aforementioned fuel cartridge further includes a frame. The solid reactant is disposed in the frame. The flexible thin film is fixed to the frame to wrap all the surfaces of the solid reactant.

In one embodiment, the liquid reactant includes water and the solid reactant includes a solid hydride and a solid catalyst.

In one embodiment, the liquid reactant includes a hydride solution and the solid reactant includes a solid catalyst.

In one embodiment, the flexible thin film has a thickness within a range from 0.1 to 5000 micrometers.

In one embodiment, the flexible thin film has a thickness within a range from 8 to 50 micrometers.

In one embodiment, the flexible thin film includes a plurality of pores. Each one of the plurality of pores has an aperture within a range from 0.01 to 100 micrometers, and the flexible thin film has a porosity factor within a range from 50% to 97%.

In one embodiment, the flexible thin film includes a plurality of pores. Each one of the plurality of pores has an aperture within a range from 0.03 to 30 micrometers, and the flexible thin film has a porosity factor within a range from 80% to 97%.

In one embodiment, the flexible thin film includes a material selected from a group consisting of a polytetrafluoroethylene film, a polyurethane film, a fiber woven fabric, a polyester woven fabric, a blending woven fabric of polyester fiber and cotton fiber, and a nonwoven geotextile.

In one embodiment, the storage container includes a deformable bag.

In one embodiment, the deformable bag includes a material selected from a group consisting of an aluminum foil bag, a plastic bag, and a nylon bag.

In one embodiment, the transmission device includes a pump, an inlet pipe and an outlet pipe. The pump is disposed outside the outer housing. The outlet pipe is connected between the storage container and the pump. The inlet pipe is connected between the solid reactant and the pump.

In summary, the fuel cartridge of the present invention includes a flexible thin film and an elastic waterproof membrane. Specifically, the elastic waterproof membrane can prevent a liquid reactant leaked by a storage container from flowing out of the outer housing of the fuel cartridge; thus, the potentiality of a damage caused by the leaked liquid reactant flowing into the fuel cell is avoided. In addition, because the flexible thin film can filter out the bubbles formed from the reaction and thereby prevent the formed bubbles from entering into the fuel cell; thus, the potentiality of a damage caused by the formed bubbles entering into the fuel cell is avoided.

### BRIEF DESCRIPTION OF THE DRAWINGS

The invention will become more readily apparent to those ordinarily skilled in the art after reviewing the following detailed description and accompanying drawings, in which:

FIG. 1 is a cross-sectional view of a fuel cartridge in accordance with an embodiment of the invention;

FIG. 2 is a cross-sectional view of a fuel cartridge in accordance with another embodiment of the invention;

FIG. 3 is a cross-sectional view of a fuel cartridge in accordance with another embodiment of the invention; and

FIG. 4 is a cross-sectional view of a fuel cartridge in accordance with another embodiment of the invention.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

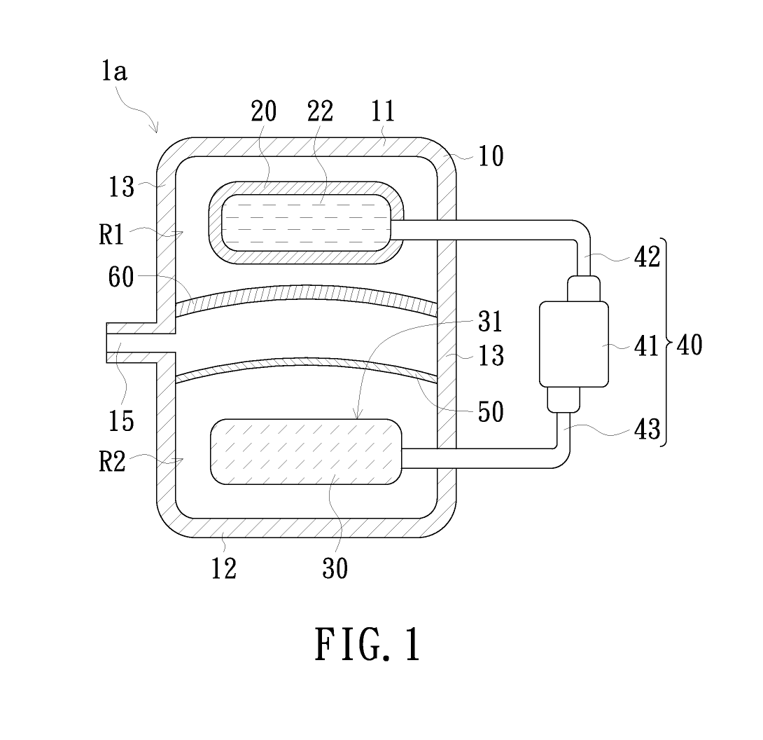

FIG. 1 is a cross-sectional view of a fuel cartridge in accordance with an embodiment of the invention. Referring to FIG. 1, the fuel cartridge 1a in this embodiment is for providing a reaction gas to a fuel cell (not shown). The fuel cartridge 1a includes an outer housing 10, a storage container 20, a solid reactant 30, a transmission device 40, a flexible thin film 50 and an elastic waterproof membrane 60. The outer housing 10 has a top wall 11, a bottom wall 12 and a plurality of side walls 13 connected between the top wall 11 and the bottom wall 12. In addition, a vent 15 is disposed on the outer housing 10. The storage container 20 is stored with a liquid reactant 22. The solid reactant 30 is disposed in the outer housing 10 and has a top surface 31. The transmission device 40, connected between the storage container 20 and the solid reactant 30, is for transmitting the liquid reactant 22 to the solid reactant 30; and a gas is generated by a reaction of the solid reactant 30 with the liquid reactant 22. In addition, the flexible thin film 50, having gas permeability and water impermeability features, is disposed between the top wall 11 and the bottom wall 12 and located above the top surface 31 of the solid reactant 30. Specifically, an orthographic projection of the flexible thin film 50, on the plane where the top surface 31 of the solid reactant 30 is, completely covers the top surface 31. The elastic waterproof membrane 60 is connected to the plurality of side walls 13 of the outer housing 10 and disposed between the storage container 20 and the flexible thin film 50.

The flexible thin film 50 is, for example, connected to the plurality of side walls 13 and thereby the interior of the outer housing 10 is divided into a first chamber R1 and a second chamber R2. Specifically, the first chamber R1 is defined between the top wall 11 and the flexible thin film 50, and the second chamber R2 is defined between the bottom wall 12 and the flexible thin film 50. In one embodiment, the storage container 20 is disposed in the first chamber R1 and the solid reactant 30 is disposed in the second chamber R2. In another embodiment, the storage container 20 is disposed in the second chamber R2 and the solid reactant 30 is disposed in the first chamber R1. Additionally, the vent 15 is disposed in one of the plurality of side walls 13 and located between the flexible thin film 50 and the elastic waterproof membrane 60. After passing through the flexible thin film 50, the generated gas can be discharged through the vent 15 and further delivered into the fuel cell.

In the fuel cartridge 1a, the transmission device 40 includes a pump 41, an outlet pipe 42 and an inlet pipe 43. Specifically, the pump 41 is disposed outside the outer housing 10; the outlet pipe 42 is connected between the storage container 20 and the pump 41; and the inlet pipe 43 is connected between the solid reactant 30 and the pump 41. In one embodiment, the inlet pipe 43 extends into the inner of the solid reactant 30 and may have a plurality of water outlets (not shown) for enhancing the reaction of the solid reactant 30 with the liquid reactant 22. In another embodiment, the inlet pipe 43 is disposed beside the solid reactant 30. The pump 41 is for transmitting the liquid reactant 22 in the storage container 20 to the solid reactant 30, so that the solid reactant 30 can have a reaction with the liquid reactant 22 for generating a gas in the second chamber R2.

In the embodiment, the storage container 20 may be, but not limited to, a deformable bag. The deformable bag may include a material selected from a group consisting of an aluminum foil bag, a plastic bag, and a nylon bag; but the invention is not limited thereto. The liquid reactant 22 may be selected from a group consisting of water, a salt aqueous solution containing ruthenium, cobalt, nickel, copper, iron, an acidic aqueous solution, an alkaline aqueous solution, an alcohol solution, and a mixed solution thereof. Being flexible and shapeable, both of the flexible thin film 50 and the elastic waterproof membrane 60 can provide an additional space for the expanded volume of the solid reactant 30 caused by the reaction with the liquid reactant 22. Because the storage container 20 is deformable, when the liquid reactant 22 is transmitted to the solid reactant 30 by the transmission device 40, the volume of the storage container 20 gradually decreases and the volume of the solid reactant 30 gradually expands. The flexible thin film 50 and the elastic waterproof membrane 60 can have a form variation in response to the volume changes of the storage container 20 and the solid reactant 30; thus, the purpose of space adjustment is achieved. Thus, there is no need to save an extra space in outer housing 10 for the expansion of the solid reactant 30. As a result, the volume of the fuel cartridge 1a can be scale-down, the available space occupied by the fuel cartridge 1a can be reduced, and fuel cartridge 1a can be designed to have an easy-to-carry feature.

In one embodiment, the solid reactant 30 may have a porous structure. Specifically, the solid reactant 30 may be solid hydride or solid hydride mixed with solid catalyst, but the invention is not limited thereto. The hydride in the solid reactant 30 may be selected from a group consisting of borohydrides, nitrogen hydrides, hydrocarbons, metal hydrides, boron-nitrogen hydrides, boron hydrocarbons, nitrogen hydrocarbons, metal borohydrides, metal nitrogen hydrides, metal hydrocarbons, metal boron nitrogen hydrides, metal boron hydrocarbons, metal nitrogen hydrocarbons, boron-nitrogen hydrocarbons, metal boron-nitrogen hydrocarbons, and a combination thereof. Specifically, the hydride may be selected from a group consisting of sodium borohydride (NaBH₄), sodium hydride (NaH), lithium borohydride (LiBH₄), lithium hydride (LiH), calcium hydride (CaH₂), calcium borohydride (Ca(BH₄)₂), magnesium borohydride (MgBH₄), potassium borohydride (KBH₄), aluminum borohydride (Al(BH₄)₃), and a combination thereof. Moreover, the hydride of the solid reactant 30 may be selected from a group consisting of chemical hydride with experimental formula BₓN_{y}H_{z} and various compounds with experimental formula BₓN_{y}H_{z}, such as ammonia borane (H₃BNH₃), diamino diborane, H₂B(NH₃)₂BH₄, poly-(amino-borane), borazine (B₃N₃H₆), morpholineborane, borane-tetrahydrofuran complex, diborane and the like. The catalyst of the solid reactant 30 may be selected from a group consisting of solid acid, saline containing rethenium, cobalt, nickel, copper and iron, solid catalyst made thereof with ionic form, solid catalyst made thereof with ionic form on a carrier, solid catalyst made thereof with metallic form, and solid catalyst made thereof with metallic form on a carrier.

In one embodiment, the flexible thin film 50 may have a thickness within a range from 0.1 to 5000 micrometers. In one preferred embodiment, the flexible thin film 50 may have a thickness within a range from 8 to 50 micrometers. In addition, the flexible thin film 50 may have a plurality of pores (not shown), but the invention is not limited thereto. Each one of the plurality of pores may have an aperture within a range from 0.01 to 100 micrometers, and the flexible thin film 50 may have porosity within a range from 50% to 97%. In one preferred embodiment, each one of the plurality of pores may have an aperture within a range from 0.03 to 30 micrometers; and the flexible thin film 50 may have porosity within a range from 80% to 97%. Besides, the flexible thin film 50 may include, but not limited to, a material selected from a group consisting of a polytetrafluoroethylene (PTFE) film, a polyurethane (PU) film, a fiber woven fabric, a polyester woven fabric, a blending woven fabric of polyester fiber and cotton fiber, and a nonwoven geotextile. In one embodiment, the elastic waterproof membrane 60 may be selected from a group consisting of a rubber film, a gas-impermeable plastic film, and other flexible gas-impermeable membrane film.

The fuel cartridge 1a in this embodiment includes the flexible thin film 50 and the elastic waterproof membrane 60. Specifically, the elastic waterproof membrane 60 can prevent the liquid reactant 22 leaked by the storage container 20 from discharging through the vent 15 and then flowing out of the fuel cartridge 1a; thus, the potentiality of a damage caused by the leaked liquid reactant 22 flowing into the fuel cell is avoided. In addition, because the flexible thin film 50 can filter out the bubbles formed from the reaction and thereby prevent the formed bubbles from entering into the fuel cell; thus, the potentiality of a damage caused by the formed bubbles entering into the fuel cell is avoided. In addition, because both of the flexible thin film 50 and the elastic waterproof membrane 60 have waterproof feature, the liquid mixed with the dissolved solid fuel in the solid reactant 30 is prevented from discharging through the vent 15 of the outer housing 10 and then flowing into the fuel cell even when the fuel cartridge 1a is inverted; thus, the potentiality of a damage caused by the aforementioned liquid flowing into the fuel cell is avoided. In addition, when the storage container 20 is broken caused by an accidental breakout, both of the flexible thin film 50 and the elastic waterproof membrane 60 can prevent the liquid reactant 22 and the solid reactant 30 from directly contacting to each other; thus, the occurrence of a great amount of gas generated in a relatively short time as well as the occurrence of an excessive inner pressure in the fuel cartridge 1a are avoided.

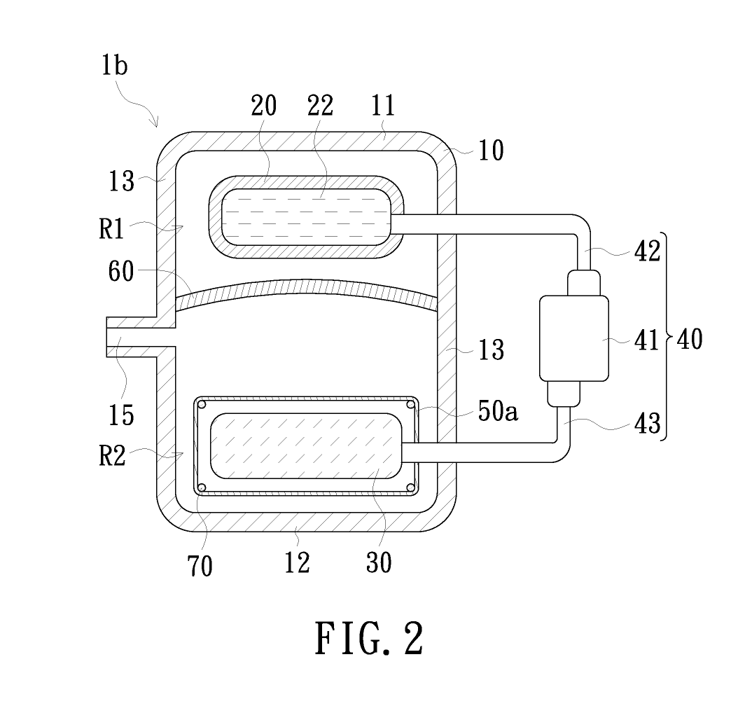

FIG. 2 is a cross-sectional view of a fuel cartridge in accordance with another embodiment of the invention. Referring to FIG. FIG. 2, it is to be noted that the fuel cartridge 1b in the embodiment has a structure similar to that of the fuel cartridge 1a shown in FIG. 1, and accordingly the fuel cartridge 1b in the embodiment can have the advantages similar with that provided by the fuel cartridge 1a shown in FIG. 1. The main difference between the fuel cartridge 1b in this embodiment and the fuel cartridge 1a shown in FIG. 1 is the flexible thin film 50a in the fuel cartridge 1b has a multi-surface structure for wrapping all surfaces of the solid reactant 30 and thereby a plurality of air-permeable surfaces are formed. Thus, if any one of the plurality of air-permeable surfaces of the flexible thin film 50a is clogged, it is guaranteed that the generated gas still can pass through the flexible thin film 50a through the remaining air-permeable surfaces thereof and eventually to be discharged through the vent 15. In addition, the fuel cartridge 1b further includes a frame 70 as shown in FIG. 2. Specifically, the solid reactant 30 is disposed in the frame 70 and the flexible thin film 50a is fixed to the frame 70; thus, it is easier for the flexible thin film 50a to wrap the solid reactant 30. In one embodiment, the frame 70 may have a structure corresponding to that of the solid reactant 30. For example, the frame 70 may have a hexahedral structure if the solid reactant 30 has a similar structure; however, it is understood that the present invention is not limited thereto. In another embodiment, the structure of the frame 70 may not be necessary to correspond to that of the solid reactant 30. In addition, it is understood that the frame 70 in this embodiment can also be applied to the fuel cartridge 1a shown in FIG. 1.

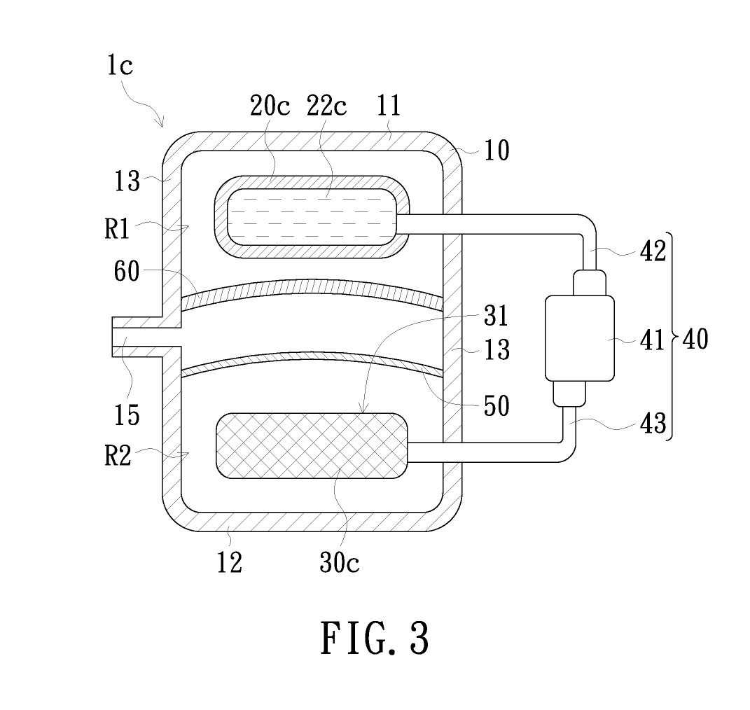

FIG. 3 is a cross-sectional view of a fuel cartridge in accordance with another embodiment of the invention. Referring to FIG. 3, it is to be noted that the fuel cartridge 1c in the embodiment has a structure similar to that of the fuel cartridge 1a shown in FIG. 1; and accordingly the fuel cartridge 1c in the embodiment can have the advantages similar with that provided by the fuel cartridge 1a shown in FIG. 1. The main difference between the fuel cartridge 1c in this embodiment and the fuel cartridge 1a shown in FIG. 1 is the liquid reactant 22c stored in the storage container 20c of the fuel cartridge 1c includes hydride aqueous solution, and the solid reactant 30c includes solid catalyst but not solid hydride. The hydride in the hydride aqueous solution may contain a material selected from a group consisting of all the materials contained in the above-mentioned solid hydride; and the solid catalyst may contain a material selected from a group consisting of all the materials contained in the above-mentioned solid catalyst. In one preferred embodiment, the hydride aqueous solution may have a concentration within a range from 1 wt. % to 51 wt. %.

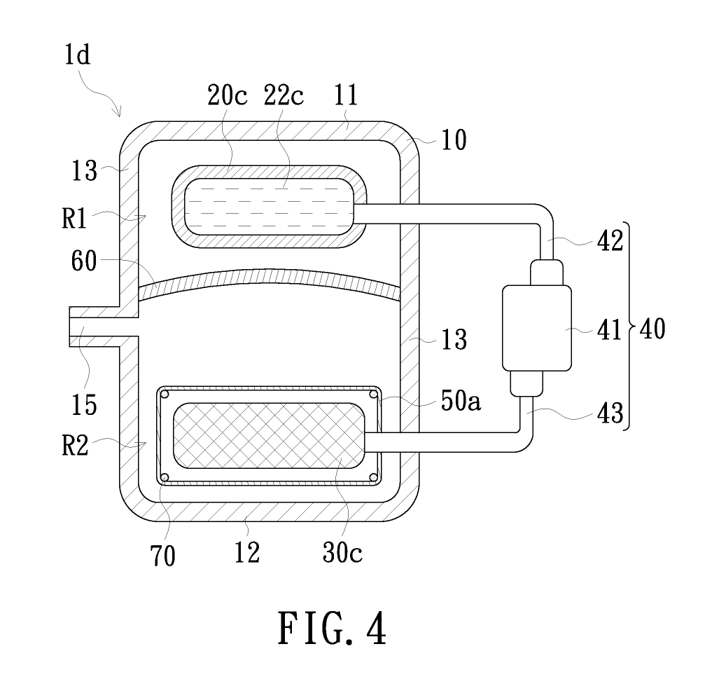

FIG. 4 is a cross-sectional view of a fuel cartridge in accordance with another embodiment of the invention. Referring to FIG. 4, it is to be noted that the fuel cartridge 1d in the embodiment has a structure similar to that of the fuel cartridge 1c shown in FIG. 3, and accordingly the fuel cartridge 1d in the embodiment can have the advantages similar with that provided by the fuel cartridge 1c shown in FIG. 3. The main difference between the fuel cartridge 1d in this embodiment and the fuel cartridge 1c shown in FIG. 3 is the flexible thin film 50a in the fuel cartridge 1d has a multi-surface structure for wrapping all surfaces of the solid reactant 30c and thereby a plurality of air-permeable surfaces are formed. Thus, if any one of the plurality of air-permeable surfaces of the flexible thin film 50a is clogged, it is guaranteed that the generated gas still can pass through the flexible thin film 50a through the remaining air-permeable surfaces thereof and eventually to be discharged through the vent 15. In addition, the fuel cartridge 1d further includes a frame 70 as shown in FIG. 4. Specifically, the solid reactant 30c is disposed in the frame 70 and the flexible thin film 50a is fixed to the frame 70; thus, it is easier for the flexible thin film 50a to wrap the solid reactant 30c. In one embodiment, the frame 70 may have a structure corresponding to that of the solid reactant 30c. For example, the frame 70 may have a hexahedral structure if the solid reactant 30c has a similar structure; however, it is understood that the present invention is not limited thereto. In another embodiment, the structure of the frame 70 may not be necessary to correspond to that of the solid reactant 30c. In addition, it is understood that the frame 70 in this embodiment can also be applied to the fuel cartridge 1c shown in FIG. 3.

In summary, the fuel cartridge of the invention includes a flexible thin film and an elastic waterproof membrane. Specifically, the elastic waterproof membrane can prevent a liquid reactant leaked by a storage container from discharging out of an outer housing of the fuel cartridge through a vent and then flowing into a fuel cell (not shown); thus, the potentiality of a damage caused by the leaked liquid reactant flowing into the fuel cell is avoided. In addition, because the flexible thin film can filter out the bubbles formed from the reaction and thereby prevent the formed bubbles from entering into the fuel cell; thus, the potentiality of a damage caused by the formed bubbles entering into the fuel cell is avoided. In addition, when the storage container is broken caused by an accidental breakout, both of the flexible thin film and the elastic waterproof membrane can prevent the liquid reactant and the solid reactant from directly contacting to each other; thus, the occurrence of a great amount of gas generated in a relatively short time as well as the occurrence of an excessive inner pressure in the fuel cartridge are avoided.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fuel cartridge, comprising:
an outer housing comprising a top wall, a bottom wall and a plurality of side walls connected between the top and bottom walls, wherein a vent is disposed on the outer housing;
a storage container stored with a liquid reactant;
a solid reactant disposed in the outer housing and comprising a top surface;
a transmission device connected between the storage container and the solid reactant and for transmitting the liquid reactant to the solid reactant, wherein a gas is generated from a reaction of the solid reactant with the liquid reactant, and the generated gas is then discharged through the vent;
a flexible thin film having gas permeability and water impermeability, the flexible thin film being disposed between the top and bottom walls and located above the top surface of the solid reactant, wherein an orthographic projection of the flexible thin film on a plane where the top surface of the solid reactant is completely covers the top surface; and
an elastic waterproof membrane connected to the plurality of side walls of the outer housing and disposed between the storage container and the flexible thin film.

2. The fuel cartridge according to claim 1, wherein the flexible thin film is connected to the plurality of side walls and thereby an interior of the outer housing is divided into a first chamber and a second chamber, wherein the first chamber is defined between the top wall and the flexible thin film and the second chamber is defined between the bottom wall and the flexible thin film.

3. The fuel cartridge according to claim 2, wherein the vent is disposed in one of the plurality of side walls and located between the elastic waterproof membrane and the flexible thin film.

4. The fuel cartridge according to claim 2, wherein the storage container is disposed in the first chamber and the solid reactant is disposed in the second chamber.

5. The fuel cartridge according to claim 2, wherein all surfaces of the solid reactant are wrapped by the flexible thin film.

6. The fuel cartridge according to claim 5, further comprising a frame, wherein the solid reactant is disposed in the frame, and the flexible thin film is fixed to the frame to wrap all the surfaces of the solid reactant.

7. The fuel cartridge according to claim 1, wherein the liquid reactant comprises water and the solid reactant comprises a solid hydride and a solid catalyst.

8. The fuel cartridge according to claim 1, wherein the liquid reactant comprises a hydride solution and the solid reactant comprises a solid catalyst.

9. The fuel cartridge according to claim 1, wherein the flexible thin film has a thickness within a range from 0.1 to 5000 micrometers.

10. The fuel cartridge according to claim 1, wherein the flexible thin film has a thickness within a range from 8 to 50 micrometers.

11. The fuel cartridge according to claim 1, wherein the flexible thin film comprises a plurality of pores, each one of the plurality of pores has an aperture within a range from 0.01 to 100 micrometers, and the flexible thin film has a porosity factor within a range from 50% to 97%.

12. The fuel cartridge according to claim 1, wherein the flexible thin film comprises a plurality of pores, each one of the plurality of pores has an aperture within a range from 0.03 to 30 micrometers, and the flexible thin film has a porosity factor within a range from 80% to 97%.

13. The fuel cartridge according to claim 1, wherein the flexible thin film comprises a material selected from a group consisting of a polytetrafluoroethylene film, a polyurethane film, a fiber woven fabric, a polyester woven fabric, a blending woven fabric of polyester fiber and cotton fiber, and a nonwoven geotextile.

14. The fuel cartridge according to claim 1, wherein the storage container comprises a deformable bag.

15. The fuel cartridge according to claim 14, wherein the deformable bag comprises a material selected from a group consisting of an aluminum foil bag, a plastic bag, and a nylon bag.

16. The fuel cartridge according to claim 1, wherein the transmission device comprises:
a pump disposed outside the outer housing;
an outlet pipe connected between the storage container and the pump; and
an inlet pipe connected between the solid reactant and the pump.
